(19) United States
(12) Patent Application Publication
(10) Pub. No.: US 2006/0133202 A1
(43) Pub. Date: Jun. 22, 2006

(54) Motion sensors in a marine seismic streamer

(76) Inventor: Stig Rune Lennart Tenghamn, Katy, TX (US)

Correspondence Address: E. Eugene Thigpen;Petroleum Geo-Services, Inc., P.O. Box 42805, Houston, TX, 77242-2805, US

(21) Appl. No.: 11/021,919

(22) Filed: Dec. 22, 2004

(51) Int. Cl. G01V 1/38

(52) U.S. Cl. 367/24

(57) ABSTRACT

An apparatus is disclosed for determining particle motion in a body of water. The apparatus includes a cable adapted to be towed in the water by a vessel. A first sensor responsive to particle motion in the water is coupled to the cable. A second sensor responsive to particle motion is disposed proximate the first sensor. The second sensor is arranged such that its sensitive axis is disposed at a substantially constant displacement with respect to a sensitive axis of the first sensor. The apparatus also includes means for determining an orientation of at least one of the first and second sensors with respect to Earth's gravity.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of marine seismic data acquisition and processing. More specifically, the invention relates to methods and apparatus for determining a vertical component of seismically induced particle motion. Such components are useful for attenuating ghosts and multiple reflections in marine seismic data.

2. Background Art

In seismic exploration, seismic data are acquired by imparting acoustic energy into the Earth near its surface, and detecting acoustic energy that is reflected from boundaries between different layers of subsurface earth formations. Acoustic energy is reflected when there is a difference in acoustic impedance between adjacent layers to a boundary. Signals representing the detected acoustic energy are interpreted to infer structures and composition of the subsurface earth structures.

In marine seismic exploration, a seismic energy source, such as an air gun, or air gun array, is typically used to impart the acoustic energy into the Earth. The air gun or air gun array is actuated at a selected depth in the water, typically while the air gun or air gun array is towed by a vessel. The same vessel, or a different vessel, tows one or more seismic sensor cables, called “streamers”, in the water near the source. Generally, the streamer extends behind the towing vessel along the direction in which the streamer is seismic sensor cables, called “streamers”, in the water near the source. Generally, the streamer extends behind the towing vessel along the direction in which the streamer is towed. Typically, a streamer includes a plurality of hydrophones disposed on the cable at spaced apart, known positions along the cable. Hydrophones, as is known in the art, are sensors that generate a signal, which may be an optical or electrical signal, corresponding to the pressure of the water or to the time gradient (dp/dt) of the pressure in the water. The vessel that tows the one or more streamers typically includes recording equipment to make a record, indexed with respect to time, of the signals generated by the hydrophones in response to the detected acoustic energy. The record of signals is processed, as previously explained, to infer structures of and compositions of the earth formations below the locations at which the seismic survey is performed.

Marine seismic data often include noise resulting from ghosting and water layer multiple reflections, which arises because water has a substantially different acoustic impedance than the air above the water surface, and because water typically has a substantially different acoustic impedance than the earth formations at the bottom of the water (or sea floor).

Ghosting and water layer multiples can be understood as follows. When the air gun or air gun array is actuated, the downwardly radiating acoustic energy passes through the sea floor and into the subsurface earth formations. Some of the acoustic energy is reflected at subsurface acoustic impedance boundaries between layers of the earth formations, as previously explained. Reflected acoustic energy travels generally upwardly, and is ultimately detected by the seismic sensors on the one or more streamers. After the reflected energy reaches the streamers, however, it continues to travel upwardly until it reaches the water surface. The water surface has nearly complete reflectivity (reflection coefficient equal to unity) with respect to the upwardly traveling acoustic energy. Therefore, nearly all the upwardly traveling acoustic energy will reflect from the water surface, and travel downwardly once again. The water-surface reflected acoustic energy will also be shifted in phase by about 180 degrees from the upwardly traveling incident acoustic energy. The surface-reflected, downwardly traveling acoustic energy is commonly known as a “ghost” signal. The ghost signal causes a distinct “notch”, at a certain frequency in the acoustic energy detected by the sensors. The frequency of the notch in the detected acoustic signal is related to the selected depth at which the streamer is disposed, as is well known in the art.

The downwardly traveling acoustic energy reflected from the water surface, as well as acoustic energy emanating directly from the seismic energy source may reflect from the water bottom and travel upwardly, where it is detected by the sensors. This same upwardly traveling acoustic energy will also reflect from the water surface, once again traveling downwardly. Acoustic energy may thus reflect from both the water surface and water bottom a number of time before it is attenuated, resulting in so-called water layer reverberations. Such reverberations can have substantial amplitude within the total detected acoustic energy, masking the acoustic energy that is reflected form subsurface layer boundaries, and thus making it more difficult to infer subsurface structures and compositions from seismic data.

It is known in the art to provide cables that include pressure (or pressure gradient) sensors, typically hydrophones, and motion sensor, typically geophones, for detecting acoustic (seismic) signals. One such cable is known as an “ocean bottom cable” (“OBC”) and includes a plurality of hydrophones located at spaced apart positions along the cable, and a plurality of substantially collocated geophones on the cable. The geophones are responsive to the velocity of motion of the medium to which the geophones are coupled. Typically, for OBCs, the medium to which the geophones is coupled is the water bottom or sea floor. Using signals acquired using dual sensor cables enables particularly useful forms of seismic data processing. Such forms of seismic data processing generally make use of the fact that the ghost signal reflected from the water surface is substantially opposite in phase to the acoustic energy traveling upwardly after reflection from subsurface layer boundaries. The opposite phase of the ghost reflection manifests itself in the measured signals by having opposite sign or polarity in the ghost signal as compared with upwardly traveling acoustic energy in the signals measured by the hydrophones. Because a geophone is sensitive to the direction of propagation of the seismic signal there will be a double phase reversal between the upwardly traveling signal and the downwardly traveling signal, so that the upwardly traveling signal and the downwardly traveling signal will have the same phase in the signal detected by the geophone.

The foregoing relationship between polarities of upgoing and downgoing acoustic energy has led to a number of techniques for “deghosting” and attenuation of water layer effects. One such technique is described in U.S. Pat. No. 4,486,865 issued to Ruehle. Pairs of detectors each comprise a geophone and a hydrophone. A filter is applied to the output of the geophone and/or the hydrophone in each pair so that the frequency content of the filtered signal is adjusted. The adjustment to the frequency content is such that when the filtered signal is combined with the signal from the other sensor, the ghost reflections cancel.

U.S. Pat. No. 5,621,700 issued to Moldovenu also discloses using at least one pair of sensors in a method for attenuating ghosts and water layer reverberations.

U.S. Pat. No. 4,935,903 issued to Sanders et al. discloses a method for reducing the effects of water later reverberations which includes measuring pressure at vertically spaced apart depths, or by measuring pressure and particle motion using sensor pairs. The method includes enhancing primary reflection data for use in pre-stack processing by adding ghost data.

U.S. Pat. No. 4,979,150 discloses a method for marine seismic exploration in which output of substantially collocated hydrophones and geophones are subjected to a scale factor. It is said that the collocated hydrophones and geophones can be positioned at the sea floor or above the sea floor.

The benefits of using dual sensor cables have been well recognized. However, techniques known in the art for deghosting and multiple attenuation are typically intended for use with OBCs. Methods known in the art for deghosting and water layer multiple attenuation work for OBCs because the ghost and water layer multiple energy is typically downgoing at the sea floor, making it relatively simple to discriminate the ghosts and water layer multiples from seismic energy reflected from earth structures beneath the sea floor, which is generally upgoing.

More recently, apparatus and methods have been proposed for detecting both pressure-related seismic signals and particle motion-related seismic signals from a streamer for the purpose of being able to determine substantially deghosted and water layer multiple attenuated seismic data. The apparatus for making pressure and motion related measurements from a streamer includes a seismic streamer having both particle motion sensors and pressure sensors disposed at spaced apart locations along the streamer. In some of the techniques for determining a deghosted, water layer multiple reflection attenuated seismic wavefield from such seismic data, it is necessary to determine the particle motion in the water resulting from seismic energy. To determine the particle motion, the particle motion sensors are typically mounted in a gimbaled housing, such that the sensitive axes of the motion sensors are disposed substantially vertically at all times, even in the presence of rotation of the streamer. While effective in maintaining the desired particle motion sensor orientation, such gimbaled mounting can be expensive to build, difficult to maintain, may introduce electrical noise, and may not be as reliable overall as fixed-mounted particle motion sensors. There exists a need for apparatus and methods for determining seismic particle motion from seismic streamer sensor signals that does not require the use of gimbaled sensor mounting for the particle motion sensors.

### SUMMARY OF THE INVENTION

One aspect of the invention is an apparatus for determining particle motion in a body of water. An apparatus according to this aspect of the invention includes a cable adapted to be towed in the water by a vessel. A first sensor responsive to particle motion in the water is coupled to the cable. A second sensor responsive to particle motion is coupled to the cable and is disposed proximate the first sensor. The second sensor is arranged such that its sensitive axis is disposed at a substantially constant displacement with respect to a sensitive axis of the first sensor. The apparatus also includes means for determining an orientation of at least one of the first and second sensors with respect to Earth's gravity.

Another aspect of the invention is a method for determining particle motion of seismic signals in a body of water. A method according to this aspect includes measuring seismically induced particle motion in the body of water along a first direction having a determinable orientation with respect to vertical. Seismically induced particle motion is then measured along a second direction. The second direction has a known relationship with respect to the first direction. The measured motions along the first and second directions are combined to obtain the particle motion. In one embodiment, the orientation is determined by measuring acceleration due to gravity along the first direction.

Another aspect of the invention is a method for seismic surveying. A method according to this aspect includes actuating a seismic energy source in a body of water. Seismically induced particle motion is measured in the body of water along a first direction having a determinable orientation. Seismically induced particle motion is measured in the body of water along a second direction. The second direction has a known relationship with respect to the first direction. The measured motions along the first and second directions are combined to obtain magnitude of the particle motion in the body of water. In one embodiment, a parameter related to pressure in the water is measured proximate the measured particle motion components. The measured pressure parameter is combined with the obtained particle motion component to determine a substantially deghosted and water layer multiple attenuated seismic wavefield.

Other aspects and advantages of the invention will be apparent from the following description and the appended claims.

### BRIEF DESCRIPTION OF THE DRAWINGS

FIG. 1 shows a typical marine seismic data acquisition system which may include one embodiment of a particle motion sensor streamer according to the invention.

FIG. 2 shows an expanded view of a sensor portion of the streamer of FIG. 1.

FIG. 3 is a cross section view of the sensor portion shown in FIG. 2.

FIG. 4 shows another embodiment of a sensor system.

### DETAILED DESCRIPTION

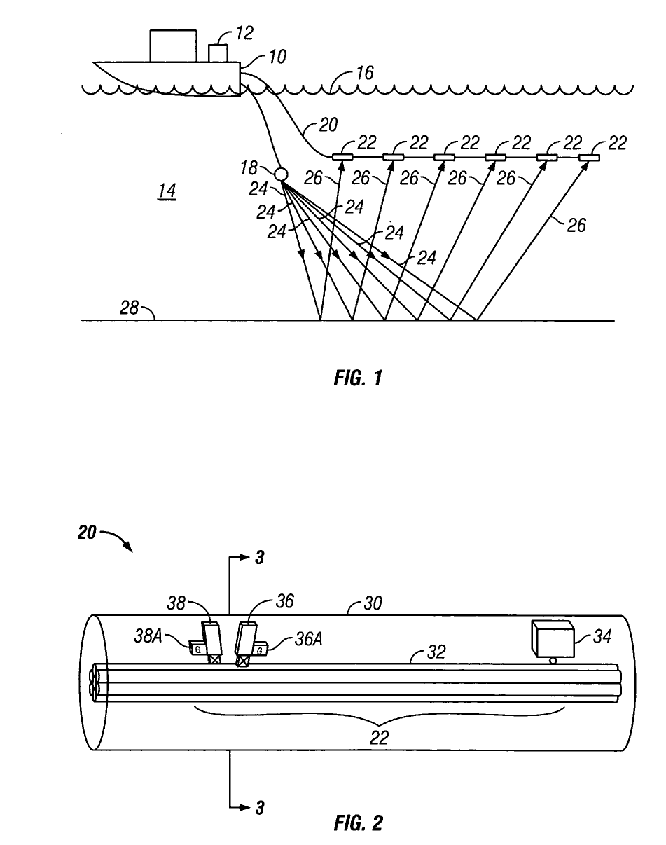

FIG. 1 shows a typical marine seismic acquisition system which can include seismic sensors according to one aspect of the invention. A seismic vessel 10 moves through a body of water 14, such as a lake or ocean. For purposes of simplifying the explanation which follows, the seismic vessel 10 is shown towing a single seismic sensor streamer 20. The streamer 20 will be explained below in more detail. In practical embodiments, a plurality of similarly configured streamers may be towed by the vessel 10. In such embodiments, the vessel 10 tows equipment (not shown) adapted to position the streamers at laterally spaced apart locations behind the vessel 10, and substantially in parallel with each other. Such arrangements of streamers, as is known in the art, are typically used for three-dimensional (3D) seismic surveys. However, it should be clearly understood that the number of streamers is not a limitation on the scope of the invention.

The vessel 10 typically includes navigation, seismic energy source control, and seismic data recording equipment (referred to for convenience hereinafter collectively as the “recording system”) of any type well known in the art and shown generally at 12. The recording system 12 causes a seismic energy source 18, towed in the water 14 by the vessel 10, to actuate at selected times. The seismic energy source 18 may be any type of energy source well known in the art, including air guns, water guns or arrays of such guns. For purposes of describing the invention, the term “source” is intended to mean any individual one or combination of seismic energy sources. The source 18 is shown being towed by the seismic vessel 10, however, in other embodiments, the source 18, or an additional one or more of such seismic energy sources (not shown) may be towed by a different vessel (not shown). In other embodiments, there may be more than one seismic energy source towed from the seismic vessel 10, or other vessel. The actual seismic energy source configuration used is not a limitation on the scope of the invention.

In some embodiments, the streamer 20 includes substantially collocated pressure and motion sensor pairs 22 disposed at spaced apart positions along the streamer 20. Each pressure and motion sensor pair 22 can include a sensor (not shown separately in FIG. 1) that is responsive to the pressure in the water 14, or to changes in such pressure (such as change in pressure with respect to time) and motion sensors comprising at least two discrete motion sensors (not shown separately in FIG. 1), each responsive to particle motion of the water 14. As is well known in the art, the pressure responsive sensor may be a hydrophone, which generates an electrical signal related to the pressure or related to changes in the pressure. The motion responsive sensors may be accelerometers (responsive to acceleration) or geophones (responsive to particle velocity). Such sensors generate an output signal, which may be an electrical or optical signal corresponding to the physical parameter being measured. The type of each of the sensors (not shown in FIG. 1) actually used in any acquisition system is not intended to limit the scope of the invention. For purposes of the invention, and as will be explained below, it is only necessary to be able to determine a component of the particle motion (or acceleration or velocity) occurring at the location of one of the sensor pairs 22 that is perpendicular to the horizontal direction of the cable. In one embodiment of the invention the amplitude of the particle motion along the direction of propagation of the signal within the plane that is perpendicular to the direction of the cable is determined. In another embodiment the vertical component of the particle motion is determined.

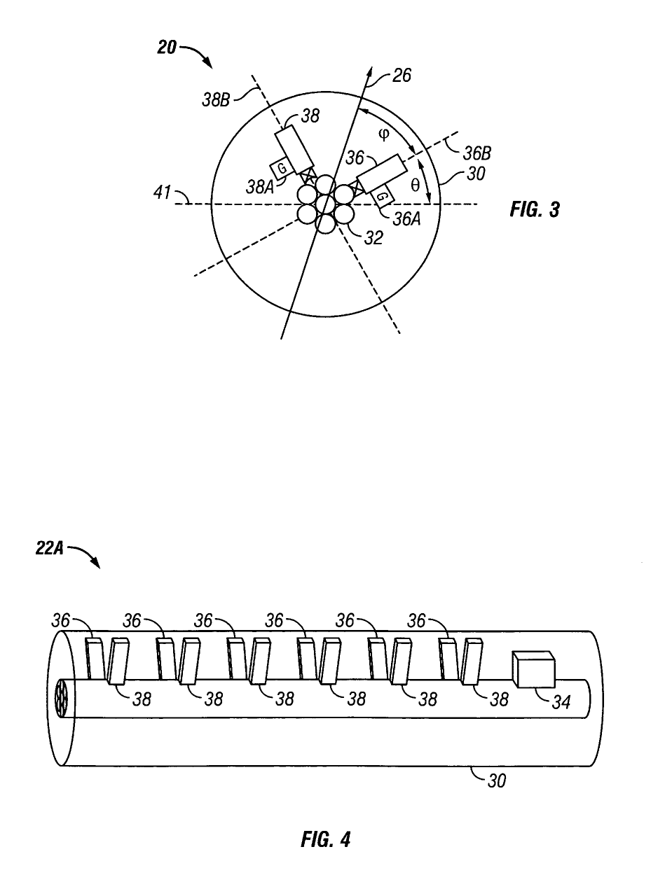

As explained in the Background section herein, one type of a sensor that can directly measure the vertical component of particle motion in the water is a geophone mounted in a gimbaled housing and having a center of gravity below the rotational axis of the gimbal mount, such that the geophone is oriented by Earth's gravity to have the sensitive axis substantially vertical at all times irrespective of any twisting or other rotation about the longitudinal axis of the streamer 20. By maintaining such orientation, the geophone response is substantially directly related to the vertical component of particle motion in the water. A streamer including both particle motion and pressure sensors is discussed in U.S. patent application Ser. No. 10/233,266, filed on Aug. 30, 2002, entitled, “Apparatus and Method for Multicomponent Marine Geophysical Data Gathering”, and assigned to the assignee of the present invention. As will be readily appreciated by those skilled in the art, adding a gimbal mount to the particle motion sensor and a gravity orienting device (such as having the gimbal axis above the center of gravity) to maintain the particle motion sensor at a substantially fixed orientation with respect to Earth's gravity (i.e., vertical) may introduce some degree of complexity to the streamer 20 and thus reduce its reliability. Further, electrical connections between the particle motion sensor and the recording system 12 preferably include some form of electrical swivel to enable free rotation of the gimbal mount while maintaining electrical continuity between the particle motion sensor and the recording system 12. Such swivels may introduce some amount of electrical noise. As will be explained below with reference to FIGS. 2 and 3, in some embodiments of the invention, signals detected by particle motion sensors mounted to the streamer 20 in a substantially rotationally fixed manner may be utilized in determining the particle motion at one or more sensor pairs 22.

During typical seismic data acquisition, the recording system 12 causes the seismic energy source 14 to be actuated at selected times. When the source 18 is actuated, seismic energy travels outwardly from the source and some of the downwardly traveling energy 24 is reflected from the acoustic impedance boundary 28 at the water bottom, as well as from other impedance boundaries below the Earth's subsurface (not shown in FIG. 1), whereupon the reflected energy travels upwardly, as shown generally at 26. The upwardly traveling seismic energy 26 is detected by the sensor pairs 22 on the streamer 20.

As will be readily appreciated by those skilled in the art, some of the upgoing seismic energy 26 is reflected from the water surface 16, whereupon it travels downwardly again and is again detected by the sensor pairs 22. Some of the water surface reflected seismic energy may be once again reflected from acoustic impedance boundaries below (such as water bottom 28). The foregoing water surface 16 reflections and water bottom reflections cause noise in the seismic signals detected by the sensor pairs 22.

Having explained the general setting in which a seismic sensor system according to the invention may be made and used, example implementations of a particle motion responsive sensor will now be explained in more detail. FIG. 2 shows a cut away view of a portion of the streamer 20 at which one of the sensor pairs (22 in FIG. 1) is disposed. The streamer 20 in the embodiment of FIG. 2 may include a strength member 32 such as may be formed from cable, wire rope or the like. Typically, the strength member 32 will be included within the interior of an acoustically transparent jacket 30. An interior space between the jacket 30 and the strength member may be filled with oil (not shown) or other material. In other embodiments, the jacket 30 may be reinforced with aramid fibers, such as Kevlar® fibers or other strength-bearing material and may itself serve as a strength member. (Kevlar is a trademark of E. I. du Pont de Nemours & Co.). Inside the jacket 30 is at least one pressure responsive sensor 34, which may be a hydrophone or the like, and at least two particle motion responsive sensors 36, 38. The pressure responsive sensor 34, and the particle motion responsive sensors 36, 38 may be rigidly or otherwise coupled to the strength member 32. In embodiments in which the jacket 30 serves as the strength member, the sensors 34, 36, 38 may be mounted to the interior of the jacket 30. Irrespective of the configuration of the jacket 30, the strength member 32 and the sensors 34, 36, 38, the streamer 20 should be arranged such that particle motion in the water (14 in FIG. 1) is freely transmitted to the motion responsive sensors 36, 38, and the pressure in the water (14 in FIG. 1) and/or changes therein, are freely transmitted to the pressure sensor 34.

As previously explained, the particle motion responsive sensors 36, 38 may be geophones, which are responsive to velocity of motion, or in one embodiment, accelerometers, which are responsive to acceleration. It may be particularly advantageous to use an accelerometer for the particle motion sensors that generate a signal that includes a static (time invariant) acceleration component in response to the Earth's gravity. An example of such an acceleraometer is the Micro Electro-Mechanical System (MEMS) accelerometer that may be obtained from Input/Output, Inc., of Houston, Tex. Thus, the signal generated by such an accelerometer used as one or more of the particle motion sensors 36, 38 will include a dynamic (time varying) component related to change in particle velocity with respect to time, and a static component related to Earth's gravity. Normally, such accelerometer will be mounted so that its sensitive axis is in a vertical plane that is perpendicular to the direction (longitudinal axis) of the streamer cable. The Earth gravity component magnitude will be related to the orientation of the accelerometer sensitive axis with respect to vertical and thus can be used in combination with the Earth gravity component measurement from another, differently oriented accelerometer that is also mounted to that its sensitive axis is in the vertical plane that is perpendicular to the direction of the streamer cable to estimate the orientation of each such accelerometer.

In other embodiments, if another type of particle motion sensor is used, such as a geophone or an accelerometer that does not have an Earth gravity measurement, it will be necessary to use an inclinometer or an accelerometer that does measure a static component that is sensitive to the Earth's gravity, shown generally at 36A and 38A, which may be coupled to a respective particle motion sensor 36, 38, or the strength member, and having a known, or determinable, orientation to the particle motion sensor 36, 38, in order to determine the orientation with respect to gravity of each particle motion sensors 36, 38. In a preferred embodiment, the inclinometer or other accelerometer may be mounted so that it is coaxial with the first sensor (36 or 38), or otherwise has the same angle of orientation. If the angle between the particle motion sensors 36, 38 is known, only one of the inclinometers or accelerometers 36A and 38A is needed. Preferably the angle between the particle motion sensors 36 and 38 is 90 degrees.

FIG. 3 shows a cross-section of the streamer 20 at the location of the particle motion sensors 36, 38, and shows orientation angles thereof which will be used to explain a method and apparatus according to the invention. A first one of the particle motion sensors 36 is coupled to the strength member 32, as explained above with reference to FIG. 2, such that its sensitive axis 36B is at an angle θ with respect to the horizontal 41. The streamer 20 may rotate within the water and the angle θ with respect to horizontal 41 may vary, but may be determined from the output signal of sensor 36, if sensor 36 is an accelerometer having a static component sensitive to the Earth's gravity. Otherwise, the angle θ may be determined by an inclinometer measurement or by a separate accelerometer 36A mounted as described above. The second particle motion sensor 38 is mounted such that its sensitive axis 38B is maintained at an essentially fixed orientation angle with respect to the first sensor 36, which preferable is 90 degrees. As with the first sensor 36, the second sensor 38 may be used to determine a component measurement of Earth's gravity directly if it is a suitable accelerometer, or may include a separate accelerometer 38A if the second sensor is, for example, a geophone. As a matter of convenience, for purposes of making measurements according to the invention, it can be assumed that the sensitive axes 36B, 38B of the particle motion sensors 36, 38, respectively, are substantially perpendicular to the longitudinal axis of the strength member 32. The axis of the strength member 32 may be assumed to be substantially horizontal, and disposed directly along the direction of motion of the streamer 20 through the water (14 in FIG. 1).

In a preferred embodiment, the relative orientation of the first sensor 36 with respect to the second sensor 38 is substantially equal to 90 degrees. Ninety degrees is particularly convenient because it simplifies determination of the particle motion in the water (14 in FIG. 1). Other orientations may be utilized however, and those of ordinary skill in the art would understand how to adapt the equations for other orientations. For such a 90 degree orientation, the magnitude of particle motion, G, and the direction of the particle motion with respect to the orientation of sensor 36 may be determined by the equations:

$$\begin{matrix}G = \sqrt{{G}_{1}^{2} + {G}_{2}^{2}} & ( 1 ) \\ φ = arctan \frac{{G}_{2}}{{G}_{1}} & ( 2 )\end{matrix}$$

In the foregoing expressions, G₁ and G₂ represent, respectively, the measured signals from the first 36 and second 38 particle motion sensors, and φ represents the direction of particle motion 26 with respect to the orientation of sensor 36 The angle θ is the angle between the horizontal and the sensitive axis of motion sensor 36 and is determinable from accelerometer measurements that are sensitive to the Earth's gravity or from inclinometers as discussed above.

If the amplitude along the angle of propagation in the plane that is perpendicular to the inline direction of the seismic cable is desired, the amplitude may be determined by equation 34. This value of the particle motion can be either negative (indicating downward propagation) or positive (indicating upward propagation), as determined by the following formula:
G_{ν}=G·sign[ sin(θ+φ)] (3)
where sign[ sin(θ+φ)] is equal to +1 for (θ+φ)<180°,and is equal to −1 for (θ+φ)>180°, and G_{ν} represents the signed value of particle motion.

The angle θ subtended between horizontal 41 and the sensitive axis 36A of the fist sensor 36 may be determined using a inclinometer or the static component of acceleration measurements if the sensors 36, 38 are accelerometers, or by separate measurements of acceleration, as previously explained. As will be readily appreciated by those skilled in the art, during seismic surveying, the streamer 20 will be subject to twisting or similar rotation about the axis of the strength member 32 along its length. If the first and second sensors 36, 38 are mounted close enough to each other such that their relative orientations remain essentially fixed, it is only necessary to determine the gravitational orientation of one of the two particle motion sensors 36, 38 to be able to use an expression such as equation (1) to determine the vertical component of particle motion.

Another embodiment of a streamer according to the invention is shown in FIG. 4. A sensor pair 22A will include a plurality of particle motion sensors arranged as explained above and shown generally at 36 and 38 coupled to the strength member 32 or to the jacket 30 where the jacket is used as the strength member, and preferably at least one pressure sensor 34, also as explained above. In the present embodiment a spacing along the length of the streamer between the endmost particle motion sensors is less than about one-half wavelength of mechanical noise that is expected to be induced in and/or transmitted along the streamer. In some embodiments, signals from corresponding ones of the spaced apart particle motion sensors 36 and 38, respectively, may be summed or added prior to calculating the vertical component in order to improve the signal to noise ratio.

In another embodiment, the pressure in the water (or changes therein), and particle motion components may be measured at one or more locations along the cable as described above. Signals corresponding to the vertical component of particle motion, described as explained above, may be combined with the signals corresponding to pressure or changes therein to determine a substantially deghosted and water layer multiple attenuated seismic wavefield. See, for example, U.S. patent application Ser. No. 10/233,266, filed on Aug. 30, 2002, entitled, “Apparatus and Method for Multicomponent Marine Geophysical Data Gathering”, and assigned to the assignee of the present invention for an example technique for determining a deghosted and water layer multiple attenuated wavefield.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. (canceled)

2. (canceled)

3. (canceled)

4. (canceled)

5. (canceled)

6. (canceled)

7. (canceled)

8. A method for determining a vertical component of particle motion of seismic signals in a body of water, comprising:
measuring seismically induced particle motion in the body of water along a first direction having a determinable orientation with respect to vertical;
measuring seismically induced particle motion in the body of water along a second direction, the second direction having a known relationship with respect to the first direction; and
combining the measured motions along the first and second directions to obtain the vertical component.

9. The method of claim 8 wherein the orientation is determined by measuring acceleration due to Earth's gravity substantially along the first direction.

10. The method of claim 8 wherein the first direction and the second direction subtend an angle of ninety degrees.

11. The method of claim 8 wherein the measuring particle motion along the first direction comprises measuring acceleration therealong, and the orientation is determined by measuring a static component of the measured acceleration.

12. The method of claim 8 further comprising, measuring particle motion along the first and second direction at a plurality of spaced apart locations, endmost ones of the spaced apart locations being at most about one half a wavelength of seismic sensor streamer noise, and summing the measured signals along the first and second directions, respectively.

13. A method for seismic surveying, comprising:
actuating a seismic energy source in a body of water;
measuring seismically induced particle motion in the body of water along a first direction having a determinable orientation with respect to vertical;
measuring seismically induced particle motion in the body of water along a second direction, the second direction having a known relationship with respect to the first direction; and
obtaining a vertical component of the particle motion in the body of water by combining the measured motions along the first and second directions.

14. The method of claim 13 wherein the orientation is determined by measuring acceleration due to Earth's gravity substantially along the first direction.

15. The method of claim 13 wherein the first direction and the second direction subtend an angle of ninety degrees.

16. The method of claim 13 wherein the measuring particle motion along the first direction comprises measuring acceleration therealong, and the orientation is determined by measuring a static component of the measured acceleration.

17. The method of claim 13 further comprising, measuring particle motion along the first and second direction at a plurality of spaced apart locations, endmost ones of the spaced apart locations being at most about one half a wavelength of seismic sensor streamer noise, and summing the measured signals along the first and second directions, respectively.

18. The method of claim 13 further comprising:
measuring a parameter related to pressure in the body of water proximate the measuring of particle motion along the first and second directions; and
combining the measurements of the parameter related to pressure with the obtained vertical component of particle motion to obtain a substantially deghosted and water layer multiple attenuated seismic wavefield.
